(19) United States
(12) Patent Application Publication
(10) Pub. No.: US 2009/0045223 A1
(43) Pub. Date: Feb. 19, 2009

(54) DISPENSER FOR AEROSOL FOAMS AND THE LIKE, HAVING A POST-EXPANSION CHAMBER

(75) Inventors: Keith Laidler, West Midlands (GB); Timothy Rodd, Hants (GB)

Correspondence Address: PEARSON & PEARSON, LLP, 10 GEORGE STREET, LOWELL, MA, 01852, US

(73) Assignee: Incro Limited, Stourbridge (GB)

(21) Appl. No.: 11/659,155

(22) PCT Filed: Aug. 2, 2005
(86) PCT No.: PCT/GB2005/003031

§ 371 Date: Sep. 15, 2008

(30) Foreign Application Priority Data
Aug. 3, 2004 (GB) 0417249.0
Nov. 2, 2004 (GB) 0424311.9
Mar. 1, 2005 (GB) 0504152.0

(51) Int. Cl. B67D 1/16; B65D 37/00; B65D 83/00; B65D 5/72

(52) U.S. Cl. 222/108; 222/571; 222/402.13; 222/207

(57) ABSTRACT

A dispenser device for liquors, pastes or foams and the like fluid materials comprises a reservoir (10) for fluid material, an outlet (12) for said reservoir and an outlet passage (18) to connect the reservoir outlet with an outlet orifice (19) of the device. Means (21) defining a post-expansion chamber are provided between the reservoir outlet and said outlet orifice to prevent material from escaping from the outlet after use. The post-expansion chamber is configured to increase in size once actuation of the device has stopped.

This invention relates to improvements in dispensers for foams and the like. The term “and the like” encompasses liquors which can be delivered from aerosols or other dispensers, which expand, such as shaving gels, shaving foams, shower gels and creams, soaps, toothpaste, food products, cleaning products, and various industrial products.

Dispenser caps for such liquors tend to use very narrow channels or passages, because after use the channels, for example between the dispensing mechanism and an outlet orifice, are full of the product. This product continues to expand and push at least a beadlet of product from the orifice and sometimes leads to an unsightly and wasteful dribble of product from the orifice.

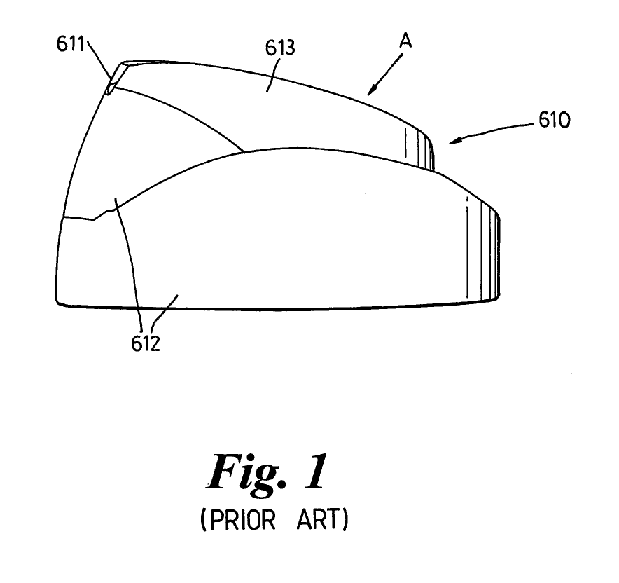

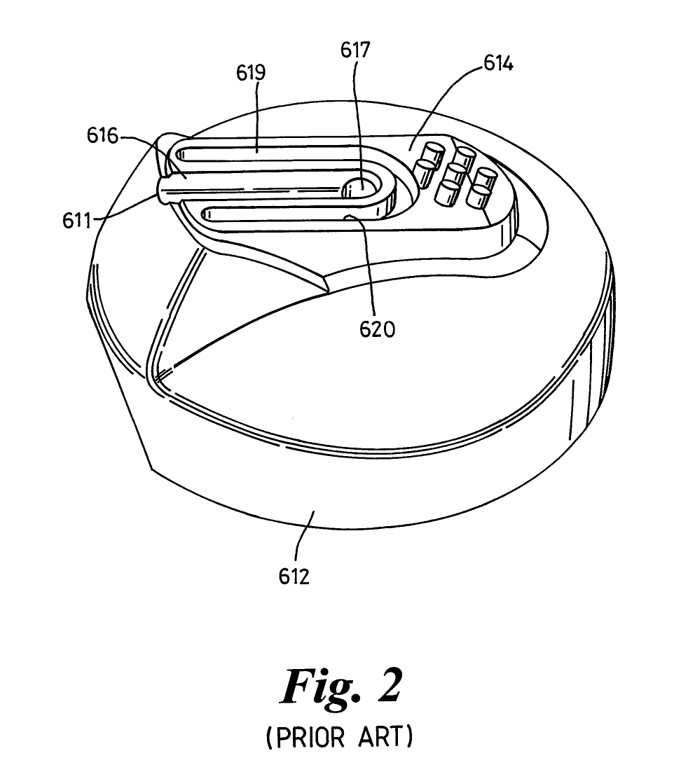

A partially successful solution for some products has been to use a channel or passage leading to the outlet orifice which has at least one resilient wall so that the channel constricts after use. An example of an outlet device in which the outlet channel has at least one resilient wall is described in the applicant's co-pending International patent application WO 2004/018111 and is shown in FIGS. 1 to 3 of the accompanying drawings, in which: FIG. 1 is a diagrammatic illustration showing a side view of a known spray-through cap nozzle arrangement; FIG. 2 is a perspective view of a lower part of the spray-through cap nozzle arrangement of FIG. 1; and FIG. 3 is a perspective view of an upper part of the spray-through cap nozzle arrangement of FIG. 1.

For a full description of the construction and operation of the known spray-through cap nozzle, the reader should refer to WO 2004/018111. However a brief description of the known spray-through nozzle follows with reference to FIGS. 1 to 3. The known spray-through cap nozzle arrangement 610 is adapted to be fitted to the end of a standard cylindrical aerosol canister (not shown). The spray-through cap nozzle arrangement 610 has a lower part 612 and an upper part 613. An outlet 611 is formed at the edge of the interface between the lower part 612 and the upper part 613.

To actuate the dispenser to cause the contents of the canister to be dispensed through the nozzle arrangement, the upper part 613 is pressed downwards in the direction of arrow A by an operator. This causes the lower part 612 of the nozzle arrangement to engage and open the valve.

As can be seen from FIGS. 2 and 3, the upper surface of the lower part 612 has an abutment surface 614 which cooperates with a corresponding abutment surface 615 on a lower surface of the upper part when the two parts are assembled. A channel or groove 616 is formed in the abutment surface 614 of the lower part 612, which groove extends from an inlet opening 617 to an edge of the abutment surface 614. The upper part 613 has ridge 618 that aligns with the groove 616 in the lower part 612 when the two parts are assembled. Between them, the ridge 618 and groove 616 define an outlet channel or passage leading from the inlet opening 617 to the edge of the abutment surfaces 614, 615 where they define the outlet 611. The ridge 618 forms a resiliently deformable wall of the outlet channel which, when the nozzle is not in use, is biased into the position shown in FIG. 3 so as to contact the surface of the groove 616 and effectively close the passage. When the nozzle is operated, the pressure of the contents of the canister entering the nozzle causes the ridge to deform upwards to open the passage and allow the contents to be dispensed. When actuation of the nozzle is stopped, the ridge 618 resiliently deforms back to the position shown in FIG. 3 to close the outlet passage of the nozzle 610 and in doing so pushes any of the contents of the canister still in the outlet passage out through the outlet 611 or back towards the inlet 617. A horseshoe shaped seal 619 surrounds the groove 616 and ridge 618 to prevent the product from leaking. The seal 619 comprises a groove 620 in the lower part 612 which receives a corresponding ridge 621 formed on the upper part 613.

The provision of an outlet passage having at least one resiliently biased wall is successful for many products but in the case of some foams and gels, these expand considerably and tend to cling initially to surfaces. Even with the best fitted caps, gaps arise, and some of the gel causes a wetted area between the internal surfaces which takes time to clear, and there are dead spaces within the valve itself and these also allow occurrence of post-foaming of the product. This may result in a small beadlet or “pea” of product issuing from the outlet orifice sometime after use of the dispenser.

It is an object of the invention to provide a dispenser for liquors, pastes or foams and the like fluid materials wherein means are provided to reduce or substantially eliminate the emergence of post-foamed gel or other material from a dispensing orifice after completion of a dispensing operation.

According to the invention, there is provided a dispenser for liquors, pastes or foams and the like fluid materials as defined in claim 1.

Additional features of the invention are to be found in the claims dependent on claim 1.

The invention may be embodied in an aerosol dispenser, a pump-action dispenser, or any other suitable dispenser.

Several embodiments of dispensers in accordance with the invention will now be described, by way of example only, with reference to the remaining drawings, wherein:—

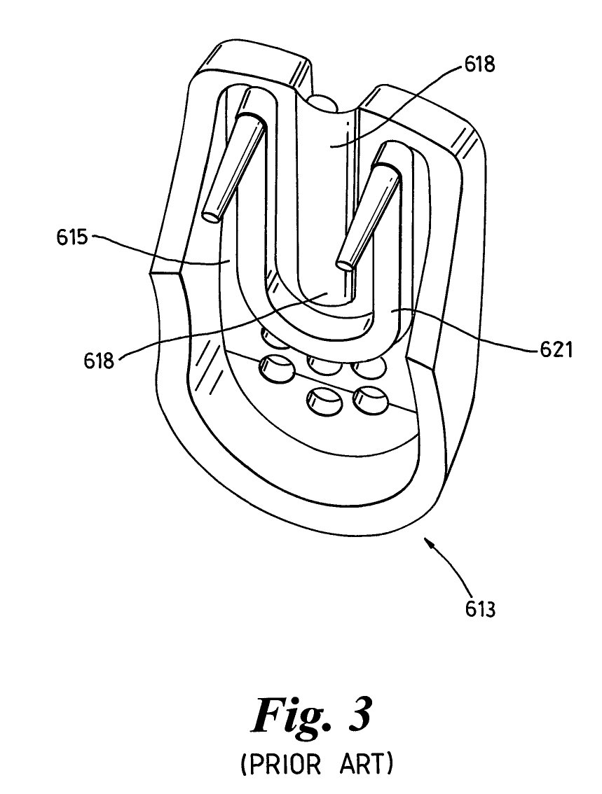

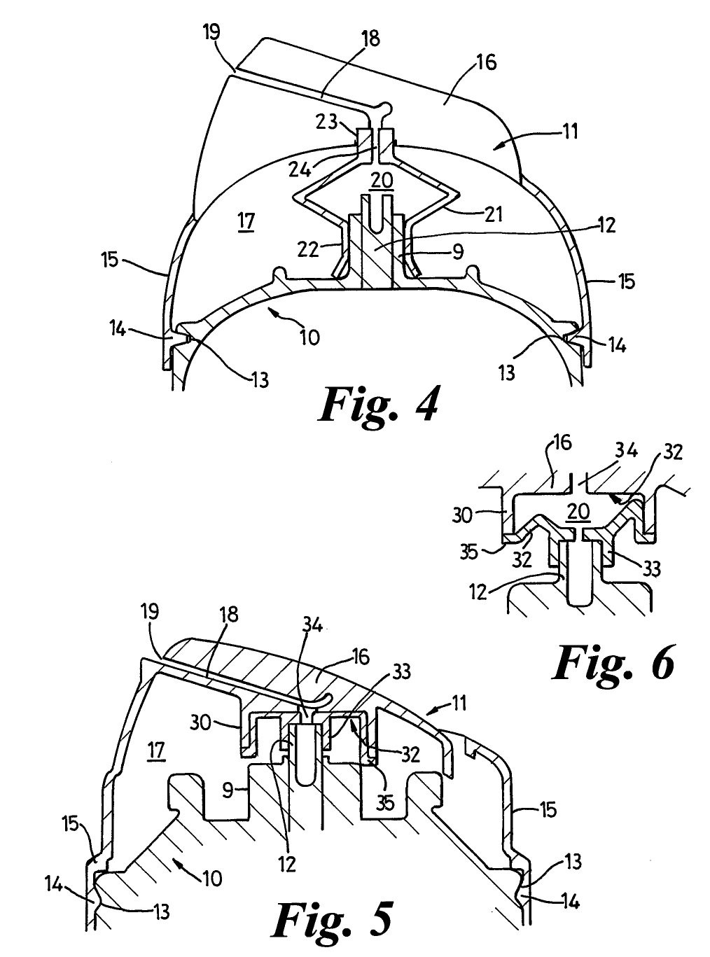

FIG. 4 is a diagrammatic cross-section of a of dispenser in accordance with a first embodiment of the invention;

FIG. 5 is a similar view to that of FIG. 4 but showing a second embodiment of dispenser in accordance with the invention, in a first state of operation;

FIG. 6 is a fragmented sectional view of the second embodiment showing a second state of operation;

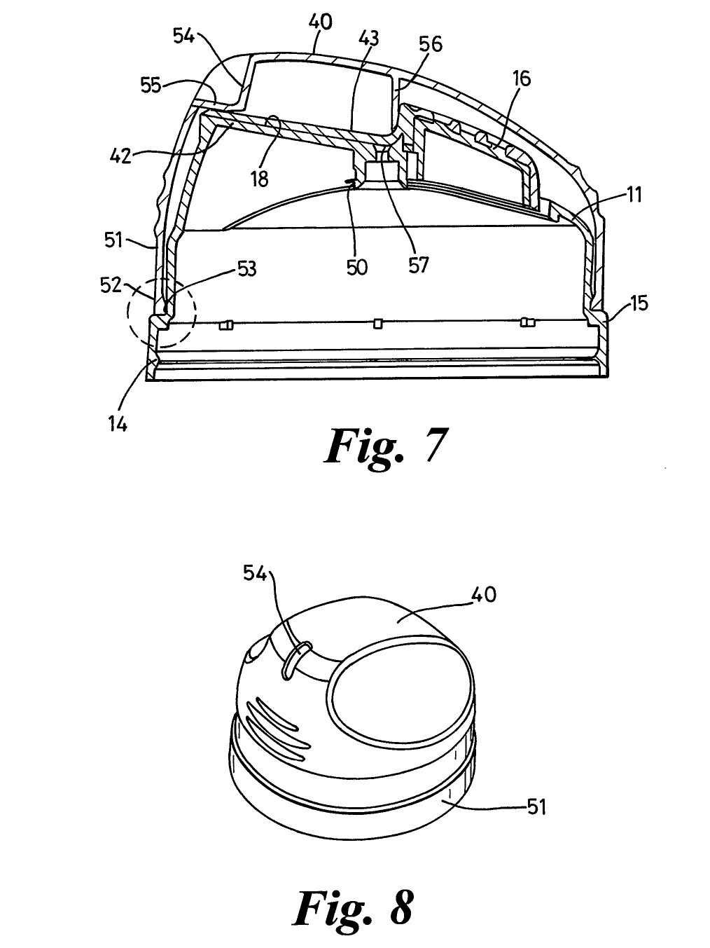

FIG. 7 is a cross sectional view of a cap and over cap forming part of a third embodiment of a dispenser in accordance with the invention;

FIG. 8 is a perspective view, in a reduce scale, of the over cap in FIG. 7;

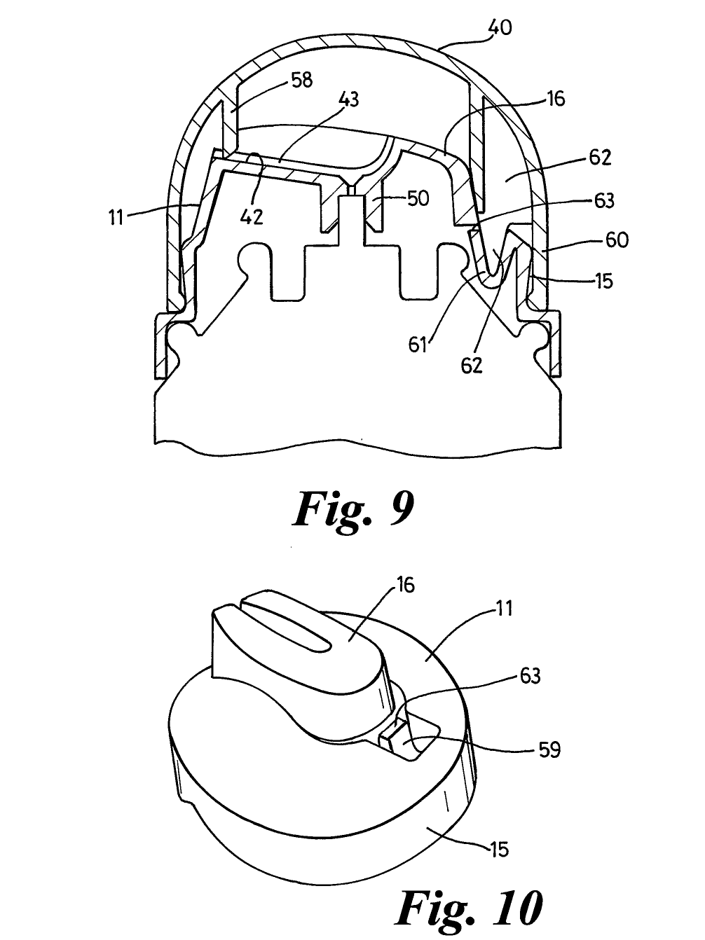

FIG. 9 is a diagrammatic cross-sectional view through a modified version of the cap and over cap of FIG. 7;

FIG. 10 is a diagrammatic perspective view of the cap of FIG. 9;

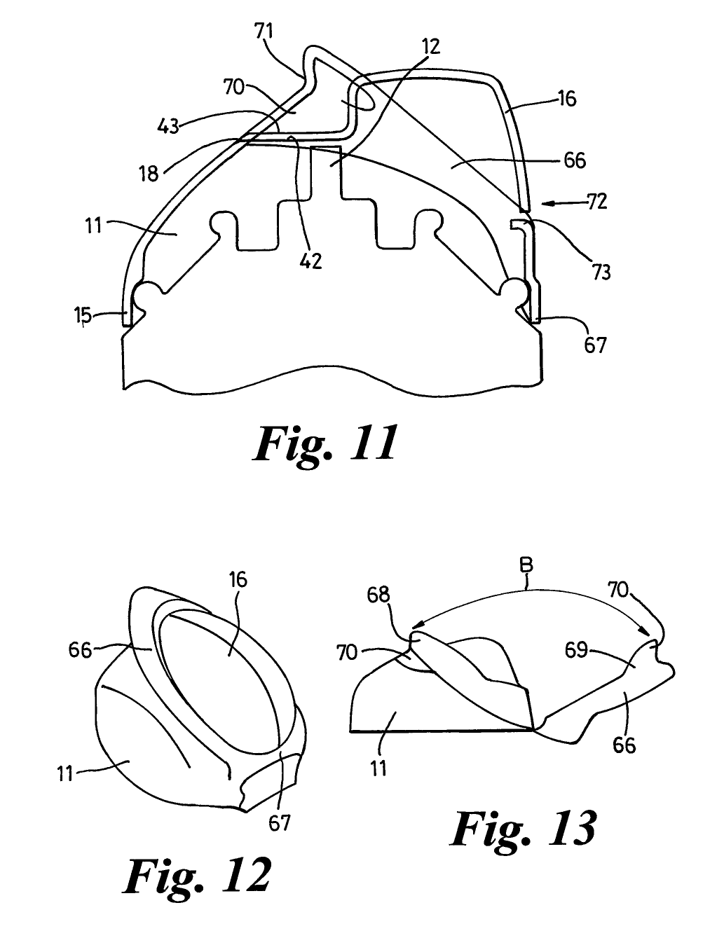

FIG. 11 is a diagrammatic sketch showing in ghost a dispenser in accordance with a fourth embodiment of the invention;

FIG. 12 is a perspective view of the cap forming part of the dispenser of FIG. 11, showing a catch in a closed and locked position;

FIG. 13 is a schematic side elevation of the cap FIG. 12, illustrating movement of a catch member between locked and unlocked positions;

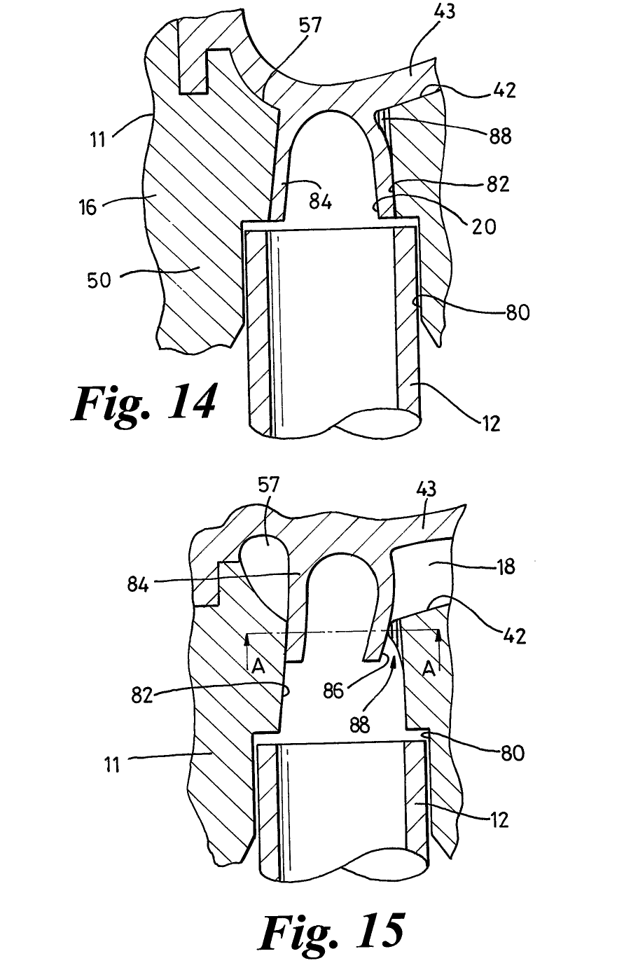

FIG. 14 is partial view of a dispenser in accordance with a further aspect of the invention in a rest state;

FIG. 15 is a view similar to FIG. 14 but showing the dispenser in an activated state for dispensing foam;

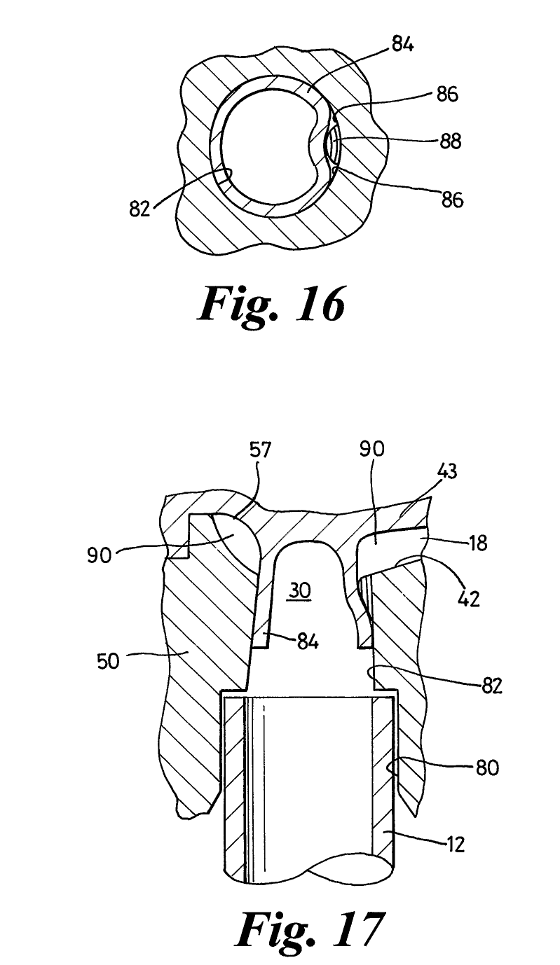

FIG. 16 is a cross sectional view taken on line A-A of FIG. 15;

FIG. 17 is a further view similar to that of FIG. 14 but showing the dispenser after activation;

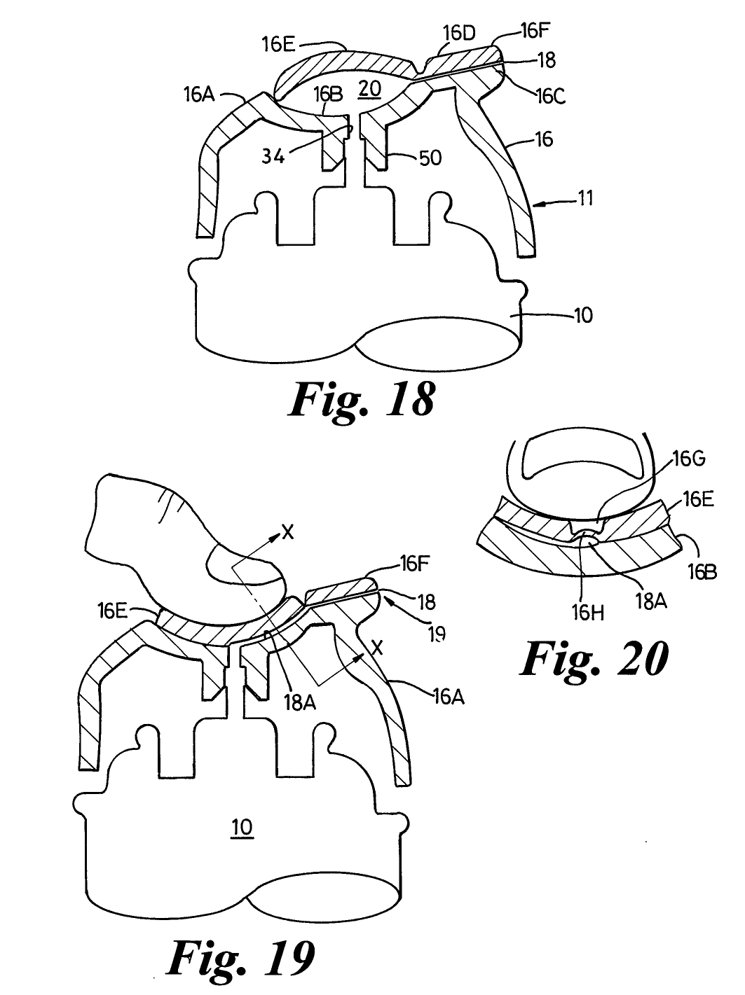

FIG. 18 is a diagrammatic cross-section of a further embodiment of dispenser in accordance with the invention in a rest state;

FIG. 19 is a view similar to that of FIG. 18 but showing the dispenser during actuation;

FIG. 20 is a cross sectional view through part of the dispenser of FIGS. 18 and 19 taken on line X-X;

Like reference numerals are used to denote like parts in the following description of the various embodiments of the invention.

FIG. 4 shows, in a diagrammatic cross-section, part of a first embodiment of dispenser for foamable gels, such as shaving gel, in accordance with the invention. In FIG. 4 there is shown the top end of a reservoir container 10 and a dispenser cap 11 which comprises an actuator means for the dispenser.

The top or discharge end of the container 10 is provided with a central discharge valve 12 in a boss or protrusion 9, and is also provided with a circumferential groove 13 which receives a rib 14 around the bottom of a skirt 15 of the dispenser cap 11. The container may be an aerosol canister. The cap 11 has a displaceable part 16 which can be pressed downwards towards the end of the container 10 to operate a dispensing mechanism. A space 17 is shown between the cap 11 and container 10 which merely allows depression of the cap part 16. Depression of the part 16 may operate the valve 12, causing it to discharge fluid from the container 10, such as shaving gel to be expelled via a passageway 18 in the cap 10 which is opened up by operation of the part 16 to leave via an outlet orifice 19. One wall of the passageway 18 e.g. the top wall may be resiliently flexible and may be constructed in a manner similar to the outlet passageway of the known spray-through cap 610 described above in relation to FIGS. 1 to 3.

In accordance with the present invention, a post-expansion chamber 20 is provided within the space 17 and this is defined by member 21 of e.g. flexible plastics material, which comprises a cylindrical skirt 22 adapted to fit snugly around the protrusion 9 containing the valve 12, a boss 23 at the other end of the member to fit in a socket in the cap 11 and having an axial bore 24 which communicates between the post-expansion chamber 20 and the passageway 18. The main part of the member 21 is comprised by a diaphragm member substantially in the form of a single-pleated bellows which acts to expand or contract the volume of the chamber 20 as the displaceable part 16 of the cap is pressed down towards the container top, or released and allowed to return to its un-depressed position.

When the part 16 is pressed, the space 17 and the post-expansion chamber 20 are reduced in volume, and any existing charge of gel therein is propelled into and along the passageway 18 to issue from the orifice 19. When the pressure on part 16 is released, and it is allowed to return to its undepressed position (being preferably resiliently biased into such un-depressed position), the space 17 and 20 are allowed to expand once more, and the valve 12 is closed stopping flow from the container 10. The post-expansion chamber 20 draws back any final bead of gel from the previous charge from passage 18 and allows it to expand in the chamber 20 as it normally would on leaving the outlet orifice 19, and the appearance of a beadlet of foam at the outlet between uses is prevented.

A second embodiment is illustrated in FIG. 5. Here again, a container 10 has a cap 11 thereon which is secured by a rib 14 on the cap engaging in a circumferential groove 13 in the container. Cap 11 has a displaceable part 16 movable into a space 17 between the cap and container, which allows displacement of part 16 to operate an outlet aerosol valve 12 in a central boss or protrusion 9. In FIG. 5, the underside of the displaceable part 16 of the cap 11 has a circular wall or fence 30 which depends downwardly therefrom and surrounds a circular recess 31 in the part 16 concentric with the valve 12 of the container. Recess 31 is shown in FIG. 5 to be lined with a flexible plastics diaphragm member 32 which has a central member 33 which is fitted securely over the valve boss 12, and has a central aperture 34 which communicates with the outlet passage 18 in the cap 11. The main part of diaphragm 32 is shown as abutting against the sides and floor of recess 31 and engaging with the rim of the wall 30 by means of a rim 35. The rim 35 and central member 33 may be force fitted or secured by welding or adhesive to ensure a secure joint to the wall 30 and valve boss 12 respectively.

FIG. 5 shows the compressed position of the dispenser. FIG. 6 shows, in a fragmentary view the expanded state of the diaphragm member 32 when the part 16 has returned to its undepressed position. The part 16 has lifted from the position of FIG. 5 where it effectively rested on the valve boss 9, and in consequence the diaphragm 32 has been deformed, due to the adhesion of its central part 33 to boss 12 and of its rim 35 to the rim of the wall 30. The diaphragm 32 has been drawn away from contact with the base of the recess 31, so that it no longer forms a lining for the recess 31, and instead a chamber 20, forming a post-expansion chamber, has been formed. This acts to draw back any gel or foamed or foamable fluid from the passageway 18, into the chamber 20 wherein the gel is allowed to foam or expand, and also avoids any belated discharge of material from the orifice 19 which would form an unsightly or potentially wasteful bead or “pea” of foam at the outlet.

In either of the first two embodiments, once the part 16 is again pressed, the post-expansion chamber 20 immediately collapses and the material therein is expelled via the normal exit route, and then the valve 12 is activated leaving the next charge of fluid to enter the passageway 18. As the new fluid meets the old fluid, it mixes and redisolves any of the latter which has dried out. The expanded product is reduced to a fraction of its expanded size when the chamber is collapsed. The diaphragms 21, 32 are not usually resilient but may be if required.

The caps 11 may be made using a bi-injection moulding process, and the chambers may be formed integrally therewith.

In a variant, the post-expansion chamber may be arranged never to be emptied, but continually recompressed so as to contain the dried out excess instead, leaving a collection of dried out waste product.

The product tends to take the easiest route so it will tend to find the post-expansion chamber rather than the outside especially if the chamber is near to the input as that is where the build up of product in the passage is greatest. Some of the product may be allowed to deliberately enter the collapsed chamber to wash out any dried up product on the way out.

The embodiments described above can be applied to dispensers having an outlet passage defined wholly by means of a rigid wall or walls or dispensers in which the outlet passage is defined by means of at least one flexible, resiliently deformable wall. With this latter type of outlet passage, there is normally a bias in the flexible part that is arranged to urge the product out through the outlet orifice. However, when a post-expansion chamber in accordance with the first two embodiments is provided, this bias could be reserved so as to urge the product into the post-expansion chamber if required.

The post-expansion chamber may be made with an extra part or adaptor that is located between the valve and the valve cup of the cap. This could be made from the same flexible material as is used to form a flexible wall of the outlet passage, and this could be located inside the valve cup on the cap and on the valve or preferably on a central metal cup or plinth that surrounds the valve. This would entail no additional cost as it would be manufactured as a one piece bi-injection moulding. If both ends are sealed then this effectively creates a pump like a bellows pump and this is preferable in many cases. This also tends to draw the product back into the chamber by suction and reduces any residual post foaming outside of the cap. The flexible outlet passage acts like a seal and can be provided with a plug arranged to enter the top of the vertical passage leading to the post-expansion chamber, so as to keep the product in the chamber wet which is easier for ejection.

Any means of creating and reducing a chamber may be used and therefore a plunger inside a tube could be used with the plunger reducing the chamber as the cap is pressed. So, for example, the plunger could be on the valve (or part of the valve) and this could push into the cap valve cup which could be extended.

The collapsible post-expansion chamber could be of any shape, including a bellows or collapsible plunger or very flexible plastic. The entire cap could define the chamber and allow the product to build up inside this chamber. The cap may then preferably be sealed by putting a flexible moulding around the actuator on the cap that is pressed by a user's finger.

The chamber could be inside the valve instead of in the cap and would work in the same way. The valve itself could alternatively collapse the channel in the same way that the cap channel is collapsed to further reduce the problem.

If the collapsible post-expansion chamber is located where a user's finger presses on the cap then it could look like a small flattened dome. The finger would depress this dome prior to moving the cap and valve. As soon as the finger is released, the dome would be free to rise, either sucking in the product like a pump or allowing it to seep in. An example of this arrangement is illustrated in FIGS. 18 to 20.

FIG. 18 shows an upper portion of a reservoir container 10 to which a dispenser cap 11 is fitted. In FIGS. 18 and 19, only a displaceable part 16 of the cap 11 is shown. The displaceable part 16 comprises a lower rigid portion 16A having a central boss 50 with a recess for receiving an outlet valve of the container 10. The rigid portion 16A includes a concave dished shaped region 16B above the central boss and an outlet passage region 16C. Mounted to the lower rigid portion 16B is an upper cover portion 16D. The upper cover portion 16D includes a flexible dome member 16E that extends over the concave dish shaped region 16B and an outlet passage region 16F which extends over the outlet passage region 16C of the lower rigid portion.

As shown in FIG. 18, in its relaxed state, the flexible dome member 16E is resiliently biased away from the concave region 16B of the lower rigid portion 16A to define a collapsible post-expansion chamber 20. A bore 34 extends from the concave region 16B through the boss 50 to connect the valve of the container with the chamber 20. An outlet passageway 18 is formed between the outlet passage regions 16C and 16F of the lower and upper portions respectively. The outlet passageway region 16F of the upper portion 16B may be resiliently flexible so as to define a resilient wall portion of the outlet passage 18 in a manner similar to the prior art dispenser cap arrangement 610 discussed above. Alternatively, the outlet passage portion 16F may define a rigid or semi-rigid wall portion of the outlet passage 18. Whilst the passageway 18 is shown in FIG. 18 to be open when the dispenser is not in use, where the passageway 18 has at least one resiliently flexible wall member, the passageway 18 will be arranged to close when not in use, in the manner of the prior art dispenser cap arrangement 610 discussed above.

When the dispenser is actuated, as shown in FIG. 19, a user presses on the flexible dome member 16E causing it to deform onto the concave region 16B such that the chamber 20 is collapsed. Thus any product contained in the chamber 20 will be compressed and forced through the outlet passageway 18. Continued pressure by the user will cause the outlet valve of the container to be actuated so that more product is dispensed through the outlet passage 18. The pressure of the product as it passes between the flexible dome member 16E and the concave region 16B causes the dome member to flex away from the concave region. However, to ensure that an outlet path through the collapsed chamber 20 is formed, the flexible dome member 16E may have a groove 16G formed along its outer surface as shown in FIG. 20. A thin wall portion 16H formed by the groove is able to flex under the pressure of the product to form a passageway 18A. It is preferable if the outlet passageway 18A, 18 is kept as small as possible so that product remains in a liquid state until it reaches the final outlet opening 19 where it is allowed to foam. Thus, the flexible portion 16E of the cap can be arranged to lift by only a very small amount to prevent the product foaming before it reaches the final outlet orifice.

When the user stops pressing on the cap 11, the flexible dome member 16E will be restored to its resiliently biased position, as shown in FIG. 18. This may draw any excess product still in the outlet passage 18 into the chamber 20 and provides a volume into which any product escaping the valve can be retained.

The dispenser cap 11 can be manufactured using a bi-injection process with the upper cover portion 16D being over moulded from a flexible plastics material on to the lower portion 16A which is moulded from a relatively rigid plastics material.

In an alternative embodiment, not shown, the post-expansion chamber 20 may be provided underneath the displaceable portion 16. Thus the flexible dome member 16E could be formed underneath the displaceable portion 16 so that it is depressed by contact with the container 10 or with some other abutment member when the displaceable portion is depressed to operate the dispenser.

In certain embodiments, part of the outlet passage 18 could become the post-expansion chamber. For example, the outlet passage could be defined in part by means of a resiliently flexible wall. The arrangement could be such that the flexible wall defines an open passage when in a rest position and pressing down on the cap would cause the passage to collapse and releasing the cap would cause it to reform. If a flexible top is used in this way, there would initially be a passage or channel and pressing the trigger would bring the flexible top into contact with a rigid base. When collapsed the flexible top would work with the pressure of the product entering the dispenser cap forcing the flexible top to rise, creating the channel and then collapsing the channel after use. Then when the trigger is released, the channel would become exposed again. If a rigid top is used then the channel would partially close so that there is still enough room for the product to pass through. Afterwards, the channel expands leaving enough room inside it for the post foaming to take place therein.

FIGS. 7 and 8 show a cap 11 and an over cap 40 of a dispenser in accordance with a further embodiment of the invention, in which the post-expansion chamber is provided as part of the outlet passage. The cap 11 in this embodiment is similar to the caps in the earlier embodiments and has a skirt 15 with a rib 14 which is adapted to be received in a corresponding groove on a container such as an aerosol canister (not shown). The cap 11 also has a displaceable part 16 with a central boss 50 for receiving an outlet valve of the container. The displaceable part can be depressed to activate the outlet valve to dispense the contents of the container.

The cap 11 has an outlet passage 18 that is at least partly defined by a resiliently deformable wall in a similar manner as the known spray-trough cap described above with reference to FIGS. 1 to 3. Thus the displaceable part 16 has a rigid portion with a groove 42 that defines a lower surface of the outlet passage 18 and a resiliently deformable ridge or wall 43 that defines an upper surface of the outlet passage. As shown in FIG. 7, when the dispenser is not in use, the wall 43 is resiliently biased to contact the opposing surface of groove 42 to close the outlet passage. When the dispenser is activated, the pressure of the contents of the aerosol container entering the outlet passage will deflect the flexible wall 43 upwardly so that it is spaced from the groove to open up the outlet passage 18. The cap 11 may be produced using a bi-injection moulding technique in which the main portion of the cap 11 is moulded in a first shot from a relatively rigid plastics material and the resiliently deformable wall 43 is over moulded onto the main portion in a second shot from a relatively flexible plastics material.

As shown in FIG. 7, an over cap 40 is adapted to be mounted over the cap 11 when the dispenser is not in use. The over cap 40, which is shown in FIG. 3 in a reduced scale, has a flexible skirt portion 51 with a ridge 52 at the end which is adapted to be a snap fit in a groove 53 provided about the cap 11 towards its base.

In accordance with the invention, a post-expansion chamber is formed in the outlet groove by clamping an end portion of the resiliently deformable wall 43 close to the outlet orifice against the groove 42 when the dispenser is not in use. This seals the end of the outlet passage 18 so that any product remaining in the outlet passage is retained between the wall 43 and the groove 42. Any expansion of the product in the groove can be accommodated by the wall 43 lifting away from the groove 42 in the centre to form a post-expansion chamber.

In the present embodiment, the end portion of the wall 43 is clamped to the groove by means of an abutment or clamp member formed in the over cap 40 that is adapted to be fitted over the cap 11 when the dispenser is not in use.

The abutment or clamp member is provided by means of a recessed portion 54 at the front of the over cap and which is positioned so as to align with the wall 43 when the over cap is fitted to the cap 11. The cap 11 and over cap 40 may have means to ensure that the over cap 40 can only be mounted on the cap 11 in the correct position to ensure that the recessed portion 54 aligns with the wall 43

The recessed portion 54 of the over cap has a base 55 which is arranged to contact an end portion of the wall 43 and to firmly hold the end portion of the wall in contact with the groove 42 when the over cap 40 is fitted to the cap 11. The base 55 may be curved to match the curve of the groove 42 to ensure that the wall 43 contacts the groove 42 over its entire width and so forms an effective seal. As described above in relation to the known spray-through cap, a horseshoe shaped seal 619 surrounds the groove 42 and the flexible wall 43. To prevent any product trapped in the outlet passage from escaping past the seal, a further abutment means in the form of a rib 56 depends from the top of the over cap to engage the resiliently deformable wall 43 close to the inlet end 57 of the outlet passage. The rib 56 is shaped to contact the flexible wall 43 and hold it in contact with the rigid surface of the groove 42. Because the product is retained in the outlet passage 18, it is sealed from the air and will tend to remain in a wet condition.

When the dispenser is to be used, the over cap is removed and the wall 43 is free to be displaced away from the groove 42 by the pressure of the contents of the container entering the outlet passage in the usual way.

A modification of the previous embodiment is illustrated in FIGS. 9 & 10. The cap 11 and over cap 40 of the embodiment shown in FIGS. 9 & 10 are similar to the cap 11 and over cap 40 of the previous embodiment except that rather than having a recessed portion, the over cap 40 of the present embodiment has a rib 58 projecting down from an upper portion for contact with an end portion of the wall 43.

The cap 11 and over cap 40 of the modified embodiment are also provided with a locking means to prevent accidental actuation of the dispenser when the over cap is fitted. A resilient tab 59 is formed in the cap 11 adjacent to the free end of the displaceable part 16. The tab 59 is generally U shaped in cross section with a first wall 60 of the U being connected to the skirt portion 51 of the cap and the second wall 61 freely extending upwardly towards a lower surface of the displaceable part 16.

In its relaxed state, the second wall 61 of the tab is positioned so that it is aligned to the right, as shown in FIG. 9, of the free end of the displaceable part 16 so that the displaceable part can be freely depressed to actuate the dispenser. The over cap 40 has a locking rib 62 that is arranged to enter the U shaped tab when the over cap is being fitted. The locking rib 62 is tapered and is configured to bias the free, second wall 61 of tab 59 to the left, as shown in FIG. 9, to bring an end surface 63 of the second wall into alignment just below the free end of the displaceable part 16 as shown in FIG. 9. With the second wall 61 of the tab in this position, downward movement of the displaceable part 16 is inhibited thus preventing actuation of the dispenser.

A problem with the previous two embodiments described above is that a user may discard the over cap 40 rather than replacing it after every use. FIGS. 11 to 13 illustrate a further embodiment of the invention in which this problem is addressed by providing the abutment that engages the resilient wall 43 on a catch member 66 that forms part of the cap 11 and so cannot be discarded.

FIG. 11 illustrates the cap 11 mounted to an upper end of an aerosol canister in a manner similar to the cap 11 of the previous two embodiments. In FIG. 11 the cap 11 is shown in ghost so that the internal details can be seen. The cap 11 has a displaceable part 16 that can be pushed downwardly by a user to operate the outlet valve of the canister in the usual way.

A catch member 66 is formed integrally with the cap 11 and is pivotally attached to the skirt 15 of the cap by means of a live hinge 67. The catch member can be moved through an arc, indicated by arrow B in FIG. 13, between a locked position 68 and an unlocked position 69. As can be seen best in FIG. 12, the main body of the catch member is in the form of a ring that defines a central generally ovoid opening through which the displaceable portion 16, which is in the form of an actuator button, projects when the catch member is in the locked position 28.

The catch member has an abutment portion 70 that is adapted to engage an outer end portion of the flexible wall 43 defining the outlet passageway 18 and to hold the wall 43 in contact with the opposing surface of the groove 42, when the catch member is in the locked position. The abutment portion is shaped so that it holds the end portion flexible wall 43 in contact with the groove over its full width so as to ensure that the outlet passage is fully sealed. Hence, with the catch member 66 n the locked position 68, a post-expansion chamber is formed in the outlet passage 18 between the remainder of the flexible wall 43 and the groove 43.

To use the dispenser cap, the catch member 66 is simply pivoted by a user to the unlocked position 69 and the dispenser cap 11 can be used in the conventional way. The catch member 66 can be shaped to make it easier to use by, for example, having a shaped formation 71 at the front that a user can easily engage to move the cap between the locked and unlocked positions. Furthermore, detent means may be provided to ensure the catch member is positively held in the locked position 68. Such detent means could take the form of abutment means on the catch member that co-operate with corresponding abutment means on the main body of the cap.

The catch member 66 also incorporates locking means 72 to prevent the dispenser cap being actuated when the catch member is in the locked position 68. As shown in FIG. 11, the catch member 66 has a tab 73 that locates below the free end of the displaceable portion 16 when the catch member is in the locked position 68. The tab 73 prevents the displaceable portion 16 from being deflected downwardly to operate the outlet valve of the canister and so prevents actuation of the dispenser. The tab 73 may also co-operate with an opening in the skirt 15 of the cap 11 to provide a detent means for positively holding the catch member 66 in the locked position.

It will be appreciated that whilst the present embodiment uses an integrally formed catch member 66, the catch member could be a separate component mounted to the cap 11. It will also be appreciated that the catch member could take many forms. For example, that catch member could be arranged to pivot in a different manner to that shown in FIGS. 11 to 13 and could take a variety of shapes. Furthermore, the catch member 66 need not be pivoted but could be arranged to slide, twist or otherwise move between the locked and unlocked positions.

FIGS. 14 to 17 illustrate a further alternative embodiment of the invention. This embodiment is a modification of the type of dispenser cap 11 shown in FIG. 7 described in detail above. In accordance with the present embodiment, a post expansion chamber 20 is provided at least partially within the central boss 50 that receives the valve stem 12 and which forms part of the displaceable portion 16 of the dispenser cap 11. This arrangement can be used either in combination with or as an alternative to the over cap 40 of the FIG. 7 embodiment. FIGS. 14, 15 & 17 show only the upper part of the central boss 50 and the inlet end 57 of the outlet passage.

The central boss 50 includes a first recessed portion 80 into which the valve stem 12 is received. A passage 82 connects the interior of the recessed portion 80 of the boss 50 with the outlet passage 18 so that the product released from the valve stem 12 can enter the outlet passage. The resiliently flexible wall 43 that defines part of the outlet passage 18 has a small circular skirt 84 which locates within the passage 82 to form a flexible bell defining a post expansion chamber 20.

FIG. 14 shows the arrangement in a rest position in which flexible wall 43 is biased against the groove 42 and the circular skirt 84 is fully received in the passage 82 and is in sealing contact with the wall of the circular passage 82.

When the dispenser is actuated, the product is dispensed under pressure from the valve stem 12 and pushes on the underside of the flexible bell defined by the skirt 84 and the flexible wall 43. The pressure of the product lifts the flexible wall 43 and the skirt 84 upwardly in the passage 82 until an opening 86 between the passage 82 and the skirt 84 is formed to allow the product to enter the outlet passage 18. In the present embodiment, the opening 86 is created by means of a projection 88 on the upper, forward edge of the wall that defines the passage 82. As shown in FIG. 16, as the skirt 84 is lifted upwardly in the passage, the projection 88 deforms part of the skirt 84 away from the wall of the passage 82 to create the opening 86 and allow the product to enter the outlet passage. In an alternative embodiment (not shown) a groove or channel can be provided in the wall of the passage 82 to connect with the outlet passage 18, the arrangement being such that upward movement of the skirt 84 will open a lower end of the groove so that product can enter the groove and pass through to the outlet passage 18.

Once actuation of the dispenser is stopped, the resilience of the flexible wall 43 will cause it to try to revert to the position shown in FIG. 14 so that the skirt 84 is biased downwardly in the passage 82, so as to once again seal with the wall of the passage 82. Any post foaming of residual product left above the valve stem 12 will initially fill the flexible bell formed by the skirt 84. Although this will tend to lift the skirt upwardly expanding the post-expansion chamber 20, it will also bias the skirt 84 outwardly into contact with the wall of the passage 82 to create a firmer seal and increase resistance to further upward movement. By appropriate selection of materials and design, it can be arranged that the resilience of the flexible wall 43 and the skirt 84 is sufficient that the pressure caused by the post foaming in the bell does not raise the skirt 84 to the point where the projection 88 deforms the skirt 84 away from the wall of the passage 82 to create the openings 86. Thus the skirt 84 will adopt a partially raised position similar to that shown in FIG. 17, in which at least a lower portion of the skirt 84 is in sealing contact with the wall of the passage 82, with the post foamed product retained in the bell or post expansion chamber 20 defined within the skirt. The volume within the skirt 84 is sealed to the air so that it keeps the foamed product moist until the next activation. Furthermore, the skirt 84 will move upwardly enough to allow some expansion of the foam so that it doesn't form a solid block even if it does dry out.

A small amount of post foaming may also occur in the outlet passage 18 itself, particularly around the inlet end 57 in the region of the skirt 84. When the flexible wall 43 and skirt 84 are moved upwardly as shown in FIG. 17, this also creates a small area 90 between the flexible wall 43 and the rigid base of the cap 11 in which the post foam product can be accommodated.

To help the skirt 84 seal in the passage 82, the passage is preferably arranged to taper inwardly from a lower, inlet end towards an upper, outlet end. However, the passage 82 could have generally parallel walls with an outwardly flaring region at the lower, inlet end against which the skirt 84 can seal. As a further alternative, rather than a flared region, the passage could have a semi-circular indent at the lower end which acts effectively like an O-ring around the bottom of the skirt.

Rather than a flexible skirt 84, other suitable seal means can be arranged to project into the passage 82 provided they can function to seal the passage to prevent post foaming product from entering the outlet passage 18 but are able to be moved or deformed sufficiently to allow the product to be dispensed when required. The seal member could be solid rather than hollow, for example.

Furthermore, rather than relying on the pressure of the dispensed product to raise the skirt 84 or other seal member, it could be arranged that the valve stem 12 engages with the skirt 84 or seal member to mechanically move it upwardly in the passage 82 when the dispenser is activated. When the dispenser is released, the valve stem will move away from the skirt 84 or other seal member to allow it to return to its rest position.

Although the present embodiment has been described with reference to the type of dispenser cap shown in FIG. 7 in which one wall 43 of the outlet passage 18 is resiliently flexible, this is not essential. By suitable modification, a resilient flexible skirt 84 or other seal member can be arranged for use with a cap in which the outlet passage 18 is defined by rigid wall members.

Dispensers in accordance with the invention may be adapted for use with a range of fluids, including gels, foams and mousses, toothpaste, soaps, food products, e.g. whipped emulsion products, and various industrial products. Whilst most of the embodiments described are aerosol type dispensers, the invention can be adapted for use with a variety of dispensers including manually actuated pumps and trigger dispensers, and squeezy tubes or bottles and any other pressurised source. Certain

Whilst the embodiments described have all included an actuator means in the form of a dispenser cap that fits on the end of a canister or other reservoir, the invention can be modified for use in dispenser devices, such as manual pump and trigger dispensers, which may not have a dispenser cap as such but which may incorporate an alternative actuator means formed integrally with or otherwise mounted to a container or reservoir.

The invention can also be modified for use with dispensers in which two or more products are mixed in a chamber prior to being dispensed. This could include dual liquor/paste dispensers of any type. Thus a post-expansion chamber could be provided downstream of the mixing chamber. The post-expansion chamber may be arranged to collapse when the dispenser is actuated but reform afterwards to accommodate any foam or other product generated as a result of residual mixing in the mixing chamber. Indeed the mixing chamber could be adapted for use as the post-expansion chamber itself. Thus a mixing chamber may be arranged such that its volume is reduced during use when it acts as a mixing chamber but to increase when the dispenser is no longer being actuated in order to accommodate any residual product. Alternatively, the mixing chamber may be positioned immediately adjacent the outlet orifice and can be adapted to collapse after use of the dispenser to force any remaining product out of the outlet. If this takes place very quickly at the end of the dispensing phase, the expelled product would become part of the main product stream rather than a post foaming or dribble.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention. For example, whilst in the embodiments disclosed the outlet is aligned generally horizontally when the dispenser is held upright, the invention can be equally applied to dispensers having a vertical outlet or an outlet arranged at any other orientation.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

1. A dispenser device for liquors, pastes or foams and the like fluid materials comprises a reservoir for fluid material, said reservoir having an outlet; the device further comprising an outlet passage means for connecting the reservoir outlet to a dispensing outlet orifice of the device and an outlet valve for controlling release of a fluid material through the outlet passage and the dispensing outlet; characterised in that the device further comprises a variable volume post-expansion chamber in the fluid path between the valve and the dispensing outlet orifice, the device being configured such that, in use, the volume of the chamber is reduced when the device is actuated to dispense a fluid and that between each actuation of the device the volume of the chamber increases to accommodate expansion of the fluid in the outlet passage means.

2. A dispenser device as claimed in claim 1, in which the device further comprises an actuator means operative to cause fluid in the reservoir to be released through the reservoir outlet.

3. A dispenser device as claimed in claim 2, in which the means defining the post-expansion chamber is operatively connected to a displaceable part of the actuator means which is adapted to be depressed to operate a dispensing mechanism of the dispenser.

4. A dispenser device as claimed in claim 3, in which the connection is such as to cause the post-expansion chamber to reduce in volume as the displaceable part of the actuator means is depressed and to increase in volume when the displaceable part is released.

5. A dispenser device as claimed in claim 4, in which the post-expansion chamber is provided between the displaceable portion of the actuator means and the outlet of the reservoir.

6. A dispenser device as claimed in claim 5, in which the means defining the post-expansion chamber comprises a member defining an enclosed or partially enclosed volume in cooperation with the outlet of the reservoir.

7. A dispenser device as claimed in claim 6, in which the member has a sleeve at one end for fitting over part of the reservoir outlet, and a plug member which is pierced with a conduit at the other which can be inserted in a recess in the actuator means for connection of the interior of the post-expansion chamber to the outlet passage.

8. A dispenser device as claimed in claim 7, in which the body of the member between the sleeve and the plug member comprises a flexible wall.

9. A dispenser device as claimed in claim 6, wherein the displaceable part of the actuator means comprises a dependent skirt formation or circular wall disposed to surround at least part of the outlet of the reservoir, and the member comprises a flexible diaphragm means received within the circular wall and sealing with the wall and a part of the reservoir outlet.

10. A dispenser device as claimed in claim 9, in which the flexible diaphragm member in a first position of the actuator means is in contact with the underside of the actuator means over substantially all of the area of the post-expansion chamber within the circular wall, and in a second position of the actuator means is separated from the underside of the actuator means, while remaining sealed to the wall and part of the reservoir outlet, thus defining said post-expansion chamber between the diaphragm and the underside of the actuator means, with the skirt or circular wall.

11. A dispenser device as claimed in claim 2, wherein the post-expansion chamber is provided in the actuator means.

12. A dispenser device as claimed in claim 11, in which the displaceable part of the actuator means comprises a rigid portion and a flexible portion, the post-expansion chamber being defined between the rigid portion and the flexible portion.

13. A dispenser device as claimed in claim 12, in which the flexible portion comprises a resilient dome like member which is biased away from the rigid portion to define the post-expansion chamber.

14. A dispenser device as claimed in claim 13, adapted such that the resilient dome like portion is deformed onto the rigid portion to collapse the post-expansion chamber when the displaceable portion is depressed to operate the dispensing mechanism.

15. A dispenser device as claimed in claim 14, in which the resilient dome like portion is arranged on an outer surface of the displaceable portion such that a user depresses the dome like portion to collapse the post-expansion chamber when depressing the displaceable portion of the actuator means to actuate the dispenser mechanism.

16. A dispenser device as claimed in claim 14, in which the resilient dome like portion is arranged on an inner surface of the displaceable portion such that the dome like portion contacts an abutment means on the reservoir or another portion of the actuator means and is depressed to collapse the post-expansion chamber when a user depresses the displaceable portion of the actuator means to actuate the dispenser mechanism.

17. A dispenser device as claimed in claim 14, in which the rigid portion comprises a concave surface region which opposes the flexible dome like portion.

18. A dispenser device as claimed in claim 1, in which the post-expansion chamber is provided as part of the outlet passage.

19. A dispenser device as claimed in claim 18, in which the outlet passage is at least partially defined between at least one resiliently deformable wall and an opposing surface, in which the resiliently deformable wall is movable from an initial resiliently biased position in which the wall abuts the opposing surface to close the outlet passage and a deformed position in which the wall is spaced from the opposing surface, the post-expansion chamber being provided between the at least one resiliently deformable wall and the opposing surface.

20. A dispenser device as claimed in claim 19, further comprising an abutment or clamp member which is adapted to engage at least part of the resiliently deformable wall to hold it in contact with the opposing surface when the dispenser is not being activated.

21. A dispenser device as claimed in claim 20, in which the abutment or clamp member is arranged to engage a part of the resiliently deformable wall at or close to the outlet orifice.

22. A dispenser device as claimed in claim 20, in which the abutment or clamp member is mounted to the actuator means so as to be movable between an operative position in which the at least a part of the resiliently deformable wall is held in contact with the opposing surface and an inoperative position in which the at least a part of the resiliently deformable wall is free to deform away from the opposing surface.

23. A dispenser device as claimed in claim 22, in which the abutment or clamp member is arranged so that it is moved between the operative and inoperative positions manually by a user of the dispenser.

24. A dispenser device as claimed in claim 23, in which the abutment or clamp member takes the form of a catch which may also incorporate a locking means to prevent actuation of the dispenser when the abutment or clamp member is in the operative position.

25. A dispenser device as claimed in claim 22, in which the abutment or clamp member is arranged to be moved automatically to the inoperative position when the dispenser actuator means is actuated to dispense the contents of the reservoir and to move back to the operative position when actuation of the dispenser is stopped.

26. A dispenser device as claimed in claim 20, in which the abutment or clamp member is provided on a component separate from the actuator means and which is adapted to be affixed to the dispenser when it is not in use.

27. A dispenser device as claimed in claim 26, in which the abutment or clamp member is provided as part of an over cap adapted to be mounted to the actuator means when the dispenser is not in use.

28. A dispenser device as claimed in claim 27, in which the over cap also comprises a locking means to prevent accidental actuation of the dispenser when it is in position on the actuator means.

29. A dispenser device as claimed in claim 2, in which the actuator means comprises a boss having a recess for receiving a stem forming part of the reservoir outlet and a first passage for fluidly connecting the recess to the outlet passage, a flexible seal means is provided in the first passage which, when the dispenser is not being actuated, engages with the wall of the first passage to define the post expansion chamber, the arrangement being such that when the dispenser is actuated, the seal means is caused to move and/or deform to create an opening between the first passage and the outlet passage through which the product can be dispensed.

30. A dispenser device as claimed in claim 29, in which the seal means is in the form of a resiliently flexible circular skirt that engages with the wall of the first passage to define a flexible dome or bell.

31. A dispenser device as claimed in claim 30, in which the skirt depends from a resiliently deformable wall forming part of the outlet passage.

32. A dispenser device as claimed in claim 30, in which the first passage tapers inwardly from an inlet end to an outlet end.

33. A dispenser device as claimed in claim 30, in which one or more projections are provided on the wall of the first passage near an outlet end thereof, the arrangement being such that when the dispenser is actuated, the skirt is moved towards the outlet end of the first passage where it contacts the projection and is deformed away from the wall of the passage to create an opening through which the product is dispensed into the outlet passage.

34. A dispenser device as claimed in claim 30, in which a groove or channel is formed in the wall of the first channel to connect the first passage with the outlet passage, which groove or channel is opened by movement of the skirt towards an outlet end of the first passage when the dispenser is actuated.

35. A dispenser device as claimed in claim 2, in which the actuator means is a dispenser cap adapted to be fitted over an end of the reservoir.

36. A dispenser device as claimed in claim 1, in which the reservoir outlet comprises the outlet valve.

37. A dispenser device as claimed in claim 36, in which the dispenser comprises an aerosol dispenser and the valve comprises an aerosol valve.

38. A dispenser device as claimed in claim 1, in which a seal means is provided to restrict the movement of fluid from the post expansion chamber to the outlet orifice when the dispenser is not being actuated.
